(19) United States
(12) Patent Application Publication
(10) Pub. No.: US 2018/0207595 A1
(43) Pub. Date: Jul. 26, 2018

(54) AUTOMATED SELECTING AND MIXING MACHINE

(71) Applicant: Wal-Mart Stores, Inc., Bentonville, AR (US)

(72) Inventors: Yurgis Mauro Bacallao, Centerton, AR (US); Bridget Leffler, Bentonville, AR (US)

(21) Appl. No.: 15/878,671

(22) Filed: Jan. 24, 2018

Related U.S. Application Data
(60) Provisional application No. 62/450,205, filed on Jan. 25, 2017.

(51) Int. Cl. B01F 13/10; G05B 11/01; B01F 11/00

(52) U.S. Cl. CPC B01F 13/1063; G06Q 30/00; B01F 11/0062; G05B 11/01

(57) ABSTRACT

An automated selecting and mixing machine including a cabin disposed within a housing structure, the cabin configured to receive a container from a user, the container containing a base medium, a container engagement element, the container engagement element being movable from a first position to a second position to manipulate a lid of the container, a plurality of dispensers, the plurality of dispensers configured to dispense an element into the container to mix with the base medium, a mixing mechanism located in the cabin, configured to manipulate the container positioned within the cabin to achieve a mixed product, and a user interface coupled to the housing structure, wherein a user selects the mixed product using the user interface to initiate an automated process of the automated selecting and mixing machine, is provided. Furthermore, an associated method, computer system, and computer program product is also provided.

### RELATED APPLICATIONS

This application claims the benefit of U.S. Provisional Patent Application No. 62/450,205, filed Jan. 25, 2017 and entitled “Automated Paint Selecting and Mixing Machine”, the contents of which are incorporated herein in their entirety.

### FIELD OF TECHNOLOGY

The following relates to an automated selecting and mixing machine, and more specifically to embodiments of an automated machine that processes a selection of a paint color to automatically deliver a desired paint, and methods thereof. The following further relates to automated processing and mixing of mixable mediums storable in a container.

### BACKGROUND

Traditionally, customers looking to purchase paint must first select a desired color from a number of available options, either in-store or online. Each paint color is assigned a name and/or number or code, which is used by a store representative to input into a conventional paint mixer. Before loading the paint can containing a base paint, the store representative must manually open a lid of the paint can, and then place the paint can into the conventional paint mixing machine. When the paint is finished mixing, the store representative must manually remove the paint can, and manually secure the lid back onto the paint can for delivery to the waiting customer. Further, the conventional paint mixing machine is located out-of-reach from customers in the store, and is exclusively operated by technicians or trained store representatives. This process requires store representative attention, as well as time to perform the manual tasks associated therewith. Moreover, other mixable mediums may similarly require manual processes to process and mix the mixable mediums.

Thus, a need exists for an apparatus and method for an automated selecting and mixing machine.

### SUMMARY OF THE DISCLOSURE

A first aspect relates generally to an automated selecting and mixing machine comprising: a cabin disposed within a housing structure, the cabin configured to receive a container from a user, the container containing a base medium, a container engagement element, the container engagement element being movable from a first position to a second position to manipulate a lid of the container, a plurality of dispensers, the plurality of dispensers configured to dispense an element into the container to mix with the base medium, a mixing mechanism located in the cabin, configured to manipulate the container positioned within the cabin to achieve a mixed product, and a user interface coupled to the housing structure, wherein a user selects the mixed product using the user interface to initiate an automated process of the automated selecting and mixing machine.

A second aspect relates generally to an automated paint selecting and mixing machine comprising: a cabin disposed within a housing structure, the cabin configured to receive a paint can from a user, the paint can containing a base paint, a paint can engagement element, the paint can engagement element being movable from a first position to a second position to manipulate a lid of the paint can, a plurality of paint colorant dispensers, the plurality of paint colorant dispensers configured to dispense a paint colorant into the paint can to mix with the paint base to achieve a desired paint color, a mixing mechanism located in the cabin, configured to mix the paint can positioned within the cabin, and a user interface coupled to the housing structure, wherein a user selects the desired paint color using the user interface to initiate an automated process of the automated paint mixing machine.

A third aspect relates generally to a method for automating a paint mixing process, comprising: initiating the paint mixing process in response to a user selecting a paint color from a user interface, removing a lid of a paint can placed within a cabin of a paint mixing machine by the user, wherein a paint can engagement element engages the lid of the paint can to remove the lid, further wherein the lid is temporarily attached to the paint can engagement element as the paint can engagement element retracts away from the paint can, dispensing a paint colorant into the paint can using a plurality of paint colorant dispensers, according to a paint colorant combination corresponding to the selected paint color, and mixing a base paint and the paint colorant.

A fourth aspect relates generally to a method, a computer system having a processor, a memory device coupled to the processor, and a computer readable storage device coupled to the processor, wherein the storage device contains program code executable by the processor via the memory device to implement a method for automating a mixing process, and computer program product having a computer readable hardware storage device storing a computer readable program code, the computer readable program code comprising an algorithm that when executed by a computer processor of a computing system implements a method for automating a mixing process. The method of automating a mixing process comprises: receiving, by a processor of a computing system, a product selection from a user operating a user interface, which initiates an automated process for obtaining a mixed product corresponding to the product selection, detecting, by the processor, a presence of a container placed within a cabin of a mixing machine by the user, wherein an access opening to the cabin is closed in response to the detection, instructing, by the processor, a container engagement element to remove a lid of the container, wherein the lid of the container is temporarily attached to the container engagement element as the container engagement element retracts away from the container, determining, by the processor, a combination of elements that when combined with a base medium inside the container, results in the mixed product corresponding to the product selection, directing, by the processor, a plurality of dispensers to dispense elements according to the combination of elements into the container, and instructing, by the processor, a mixing mechanism to shake the container to mix the elements and the base medium, wherein the access opening opens for retrieval of the container containing a final mixed product.

A fifth aspect relates generally to a method, a computer system having a processor, a memory device coupled to the processor, and a computer readable storage device coupled to the processor, wherein the storage device contains program code executable by the processor via the memory device to implement a method for automating a paint mixing process, and computer program product having a computer readable hardware storage device storing a computer readable program code, the computer readable program code comprising an algorithm that when executed by a computer processor of a computing system implements a method for automating a paint mixing process. The method of automating a paint mixing process comprises: receiving, by a processor of a computing system, a paint color selection from a user operating a user interface, which initiates an automated process for obtaining a final paint corresponding to the paint color selection, detecting, by the processor, a presence of a paint can placed within a cabin of a paint mixing machine by the user, wherein an access opening to the cabin is closed in response to the detection, instructing, by the processor, a paint can engagement element to remove a lid of the paint can, wherein the lid of the paint can is temporarily attached to the paint can engagement element as the paint can engagement element retracts away from the paint can, determining, by the processor, a paint colorant combination that when combined with a base paint inside the paint can, results in the final paint corresponding to the paint color selection, directing, by the processor, a plurality of paint colorant dispensers to dispense paint colorant according to the paint colorant combination into the paint can, and instructing, by the processor, a mixing mechanism to shake the paint can to mix the paint colorant and the base paint, wherein the access opening opens for retrieval of the paint can containing the final paint.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a front, perspective view of an embodiment of an automated selecting and mixing machine;

FIG. 2 depicts a front view of an embodiment of the automated selecting and mixing machine;

FIG. 3A depicts a perspective view of an embodiment of a container engagement element having a first embodiment of a lid securing element;

FIG. 3B depicts a perspective view of a second embodiment of the lid securing element;

FIG. 4A depicts a front view of an embodiment of the automated selecting and mixing machine, wherein the container is engaged by the container engagement element;

FIG. 4B depicts an enlarged view of FIG. 4B, wherein the container engagement element is manipulating the lid of the container;

FIG. 5 depicts a front view of an embodiment of the automated selecting and mixing machine, wherein an embodiment of a plurality of dispensers are dispensing an element into the container;

FIG. 6 depicts a rear, perspective view of an embodiment of the automated selecting and mixing machine, wherein an access door is in an open position;

FIG. 7 depicts a front view of an embodiment of the automated selecting and mixing machine, wherein the lid of the container is placed into positon and then secured on the container;

FIG. 8 depicts an embodiment of the automated selecting and mixing machine being mixed by a first embodiment of a mixing mechanism;

FIG. 9 depicts an embodiment of the automated selecting and mixing machine being mixed by a second embodiment of a mixing mechanism;

FIG. 10 depicts a perspective view of an embodiment of a component of the second embodiment of the mixing mechanism;

FIG. 11 depicts a block diagram of an embodiment of a selecting and mixing system;

FIG. 12 depicts a flow chart of an embodiment of a method for paint selecting and mixing; and

FIG. 13 illustrates a block diagram of an embodiment of a computer system for the selecting and mixing system of FIG. 11, capable of implementing methods for paint selecting and mixing of FIG. 13.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

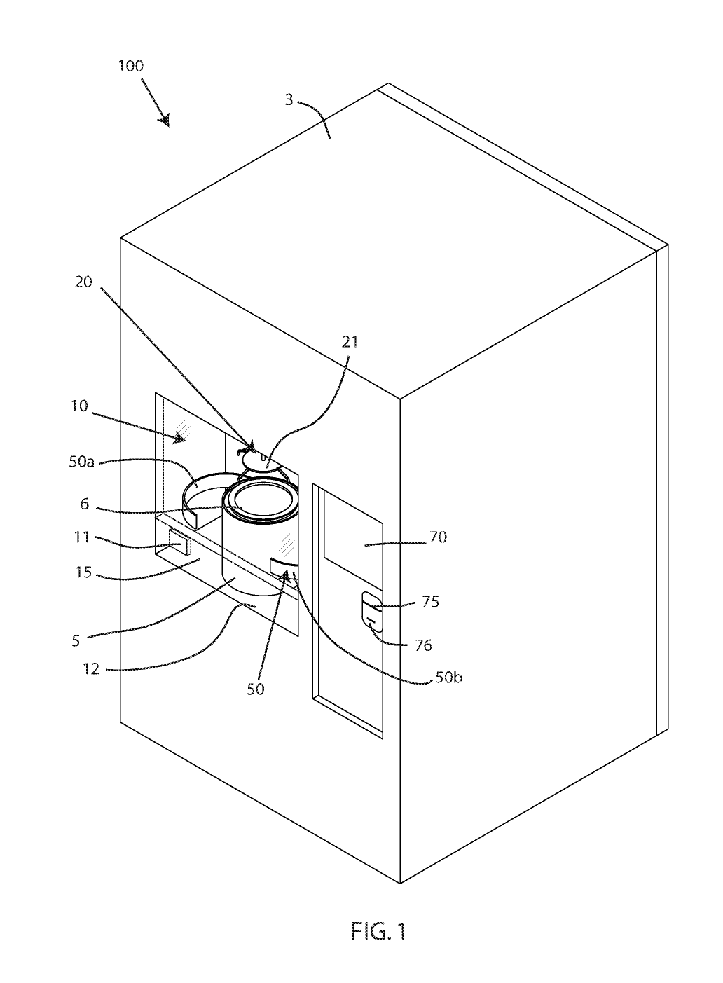

Referring to the drawings, FIGS. 1-3 depict an embodiment of a selecting and mixing machine 100 (hereinafter referred to as “machine 100”). Embodiments of machine 100 may be a mixable product mixer, a mixable product delivery device, a mixable product selection and delivery device, a mixable product mixer, an automated mixable product mixing kiosk, a self-mixing machine, a self-selection and mixing machine, a smart mixable product mixing machine, an automated mixable product creation machine, a mixable product selecting and mixing machine, and the like. Exemplary embodiments of the machine 100 may be a paint mixer, a paint delivery device, a paint selection and delivery device, a paint can mixer, an automated paint mixing kiosk, a self-paint mixing machine, a self-paint selection and mixing machine, a smart paint mixing machine, an automated paint color creation machine, a paint color selecting and mixing machine, and the like. For instance, embodiments of machine 100 may be a machine, a device, an appliance, instrument, system, computer system, electromechanical device or system, etc. that may allow a user to select a desired mixable product, such as a paint having a particular color, and obtain a container containing a base medium corresponding to the selected, desired mixable product. The user may interface directly with the machine 100 located on a salesfloor, without a sales representative operating the automated selecting and mixing machine. Embodiments of the machine 100 may be located on a salesfloor of a retailer, paint specialty store, home improvement store, grocery, restaurant, and the like, to provide customers an opportunity to select and then retrieve a finished product (i.e. sealed paint can containing paint matching the customer's desired color) automatically, without needing to interface with an operator or store representative, as well as without the need to open the container. Moreover, embodiments of the machine 100 may include a computing system that may connect to, communicate with, and/or control various hardware components and input and output devices, either over a network or direct electrical connection, as described in greater detail infra. The machine 100 may be mobile, for example, may include at least one wheel for transporting, pushing, or otherwise moving the machine 100.

Further, embodiments of the machine 100 may include a housing 3 enclosing various hardware components located therein. Embodiments of the housing 3 may be a housing, an enclosure, a frame, body, base, and the like, which may provide an overall structure or kiosk placed in a retail environment, such as a mall, a grocery store, a retail store, a salesfloor, superstore, and the like, or any environment that may offer for sale a mixable and/or otherwise customizable product, such as wood stain, paint, beverage, etc. Embodiments of housing 3 may be comprised of metal, plastic, composite, or a combination thereof, such that that exterior of the machine 100 may be rigid to an extent that the internal components may be protected or otherwise covered by the housing. The housing 3 may be the body, frame, general structure, etc., of the machine 100. The housing 3 may be defined by a plurality of walls that can define an interior region of the machine. Embodiments of the interior region may be an internal cavity, an internal space, a carriage area, an internal region, an interior space, an enclosed area, an accessibly secured area or region, a receiving area, an element supply holding region, and the like. Embodiments of the machine 100, in particular, a cabin 10 for receiving a container 5 (and the interior region) may be enclosed, substantially enclosed, fully enclosed, temporarily enclosed, accessibly enclosed, accessibly secure, and/or otherwise covered to control or secure an access to the cabin 10. Embodiments of the cabin 10 may be enclosed or covered substantially by the housing; however, a portion of the cabin 10 may be accessibly enclosed/covered by an access element 10. Further, embodiments of the machine 100 and component thereof may be comprised of metal, such as aluminum, stainless steel, metal alloys, or a combination thereof, or may be comprised of a plastic, a composite, or combinations of metal, composite, and/or metal. Moreover, embodiments of the machine 100 may be sized and dimensioned according to various specifications. The housing 3 and other components of the machine 100 may be delivered in a preassembled configuration, or may be assembled on site.

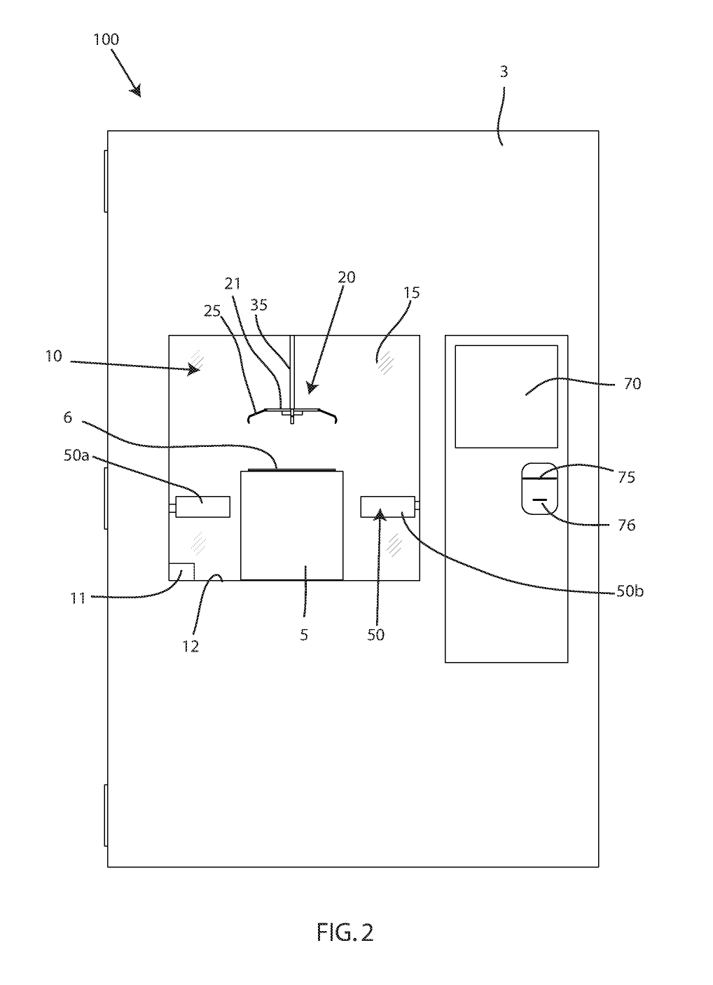

With reference to FIGS. 1 and 2, embodiments of the machine 100 may include a cabin 10, a container engagement element 20, a plurality of dispensers 40a, 40b, a mixing mechanism 50, and a user interface 70. In an exemplary embodiment, the machine 100 may include a cabin 10 disposed within a housing structure 3, the cabin 10 configured to receive a container 5 from a user via an access element 15 that opens to accept the container 5, the container containing a base medium, a container engagement element 20 having one or more fingers 25, the container engagement element 20 being movable from a first position to a second position to manipulate a lid 6 of the container 5, a plurality of dispensers 40, the plurality of dispensers 40 configured to dispense an element 41a, 41b into the container 5 to mix with the base medium to achieve a product, a mixing mechanism 50 located in the cabin 10, configured to mix the container 5 positioned within the cabin 10, and a user interface 70 coupled to the housing structure 3, wherein a user selects user the mixed product using the user interface 70 to initiate an automated process of the automated selecting and mixing machine 100.

Embodiments of the machine 100 may include a cabin 10. Embodiments of the cabin 10 may be a cabin, a paint cabin, a chamber, a paint can receptacle, a cavity, an interior region of the machine 100, a paint can receiving area, a container receiving area, a receptacle, and the like. Embodiments of the cabin 10 may located within the housing structure 3, configured to receive, accept, store, support, hold, etc. a container 5 placed within the cabin 10 by a user. The container 5 may be placed upon surface 12 within the cabin 10. Surface 12 may be a floor of the cabin 10, or may be a surface suspended within the housing structure 3, whereby the surface 12 may move independent of the other walls of the cabin 10. The cabin 10 may be defined by the surface 12, two side walls, and a back wall. The area above the cabin 10 may be open to the area within the housing 3 so that the container engagement element 20, the dispensers 40, and other components (such as lid sealing element 60) may enter the cabin 10.

Embodiments of the container 5 placeable within the cabin 10 may have a lid 6. Embodiments of the container 5 may be a conventional paint can, having a lid 6. The container 5 may be a can, a jar, a vessel, a tub, a receptacle, a bottle, a glass, a cup, an insulated container, a bucket, a canister, and the like. The container 5 for use with machine 100 may be located on a salesfloor, such as a display shelf or other accessible location for a user to pick-up and use with machine 100. Embodiments of the container 5 may initially contain a base medium. In one embodiment, the container 5 may contain a base paint, which, when combined with one or more paint colorants, may result in various paint colors. The base paint in the container 5 may be oil-based or water based paint, and may vary in finish, such as matte, flat, satin, eggshell, gloss, semi-gloss, and the like. In another embodiment, the container 5 may include a base medium of water, alcohol, a finishing agent, a solvent, a paste, a dough, a cake mix, a dairy product, a broth, a suspension, an oil, coffee, and a combination thereof. The base medium may be mixed with one or elements to achieve a mixed product, such as a paint of a desired color, ice cream, a coffee, a juice, a flavored water, a wood stain, a dessert, a bakery item ready for baking, an aerated foodstuff, a foodstuff, and soup. After a mixing step, the container 5 may include the final, mixed product.

Moreover, embodiments of the cabin 10 may also be open to the environment external to the housing 3. For instance, a receiving area or opening of the cabin 10 may be a cutout in the housing 3 that allows the user to insert and retrieve a container 5 from the cabin 10. The opening of the cabin 10 may be coverable by an access element 15. In other words, the cabin 10 may be accessible when the access element 15 is in an open position. Embodiments of the access element 15 may be a door, a panel, a glass door, a poly(methyl methacrylate) panel, a transparent plastic door, a transparent door, a security door, a transparent security panel, a cover, a slidable cover, a slidable door, a sliding panel, a pivotable door, a hinged door, an access control element, a sliding panel, a glass panel, an access panel, an access door, and the like. Embodiments of the access element 15 may be transparent, which may allow a user to view an interior space of the cabin 10 while the access element 15 is in a closed position, as shown in FIG. 2. Embodiments of the access element 15 may be a flat or substantially flat component, having a thickness, and be comprised of glass, plastic, acrylic, acrylic glass, such as an acrylic sheet, or any rigid material or combination of materials that result in a transparent access element or cover.

Embodiments of the access element 15 may move from an open position to a closed position. While in the open position, as shown in FIG. 1, a container 5 may be placed within the cabin 10. In response to an initiation of the automated process performed by machine 100 (e.g. “start” button pressed by the user operating a user interface 70 in communication with the machine 100), the access element 15 may be closed to prevent or otherwise hinder access to the cabin 10 during the automated process. For example, if a user selects a desired paint color or a desired flavored beverage to purchase via the user interface 70, a signal or command may be generated to move the access element 15 to the closed position so that the user may not be able to place a body part or other object into the cabin 10 during the automated process. In an exemplary embodiment, the access element 15 may slide in a vertical direction in response to an actuation signal, wherein the access element 15 slides behind a wall of the housing structure 3. In other embodiments, the access element 15 may slide in a horizontal direction behind a wall of the housing structure 3. A slide action or movement of the access element 15 may be accomplished by known means, such as rails, tracks, rollers, and the like. In even further embodiments, the access element 15 may pivot or hinge inwardly or outwardly into/away from the interior region of the cabin 10, or may pivot or hinge upwardly from the housing structure 3, in response to an actuation signal. A pivoting or hinging action or movement of the access element 15 may be accomplished by known means, such as a hinge or a plurality of hinges. The sliding, pivoting, or general displacement of the access element 15 may be permitted by actuating an actuator, position proximate the access element 15. The actuator may be positioned within the cabin 10, or within the housing structure 3, and may communicate with a computing system associated with the machine 100, such that in response to the automated process initiating, an actuating signal is sent to the actuator to actuate the access element 15. The actuator may comprise various embodiments of locking devices, locking means, switches, levers, motors, and the like, that when actuated by the actuator may release or drive the access element 15 in a desired direction. Because the access element 15 may be opened and closed, access to the cabin 10 of the machine 100 may be controlled.

Furthermore, embodiments of the cabin 10 may include one or more sensors 11. Embodiments of the one or more sensors 11 may include an optical sensor, a humidity sensor, a weight sensor, a paint sensor, a temperature sensor, and the like, to detect characteristics of the cabin 10, the air within the cabin 10, and the container 5 placed within the cabin 10. Further embodiments of the sensor 11 may be a sensor, a scanner, a camera, a RF transmitter/receiver, an infrared scanner, a barcode reader, a laser scanner, a camera based reader, a CCD reader, a LED scanner, and the like. The one or more sensors 11 may communicate with the computer system associated with the machine 100 either directly or over a network. In one embodiment, the sensor 11 may be an optical sensor to detect a presence of an object within a proximity of the path the access element 15 travels to move to a closed position. For example, the sensor 11 may ensure that the access element 15 may safely close without trapping a foreign object or body part (e.g. finger or hand of the user) between the access element 15 and an edge of the opening of the cabin 10. The sensor 11 may be an optical sensor that may project a laser to detect an object in between the access element 15 and an edge of the opening of the cabin 10. If an object is detected, the access element 15 can cease closing operation, and either resumes when the pathway is free of the object, or retracts to an open position and awaits a restart. In another embodiment, the sensor 11 may detect a positioning of the container 5 to ensure that the container 5 is located in a correct position within the cabin 10, and/or that the container 5 is level. If the container 5 needs to be repositioned, a signal may be sent to the computing system of the machine 100. The computing system may notify the user via the user interface 70 to readjust the container 5, and/or may prevent the access element 15 from moving to a closed position. In yet another embodiment, the sensor 11 may scan a unique identifier located on the container 5 to confirm that the user has placed a correct container 5 with the correct base medium within the cabin 10. Embodiments of the unique identifier may be a bar code, a UPC code, a SKU number, a QR code, or any computer readable two dimensional code or identifier that communicates data regarding the container 5 and the contents therein. For instance, the sensor 11 may scan the unique identifier to obtain or otherwise receive information regarding a paint base, finish, brand, ingredients, volume, and the like. The computing system associated with the machine 100 may verify that the container 5 placed within the cabin 10 is indeed the correct container 5 to be used to arrive at the user-selected mixed product, such as a desired paint color/finish.

Embodiments of the one or more sensors 11 may be positioned within the cabin 10, or may be positioned outside of the cabin 10. The cabin 10 may include a plurality of sensors, such as sensor 11, each performing an individual task, and communicating with the computing system of the machine 100. For instance, the same sensor 11 may perform multiple tasks, such as detecting a clear path of the access element 15, container alignment, and scanning a unique identifier, or multiple sensors, such as sensor 11, may be disposed within or proximate the cabin 10 to perform tasks individually and/or independently.

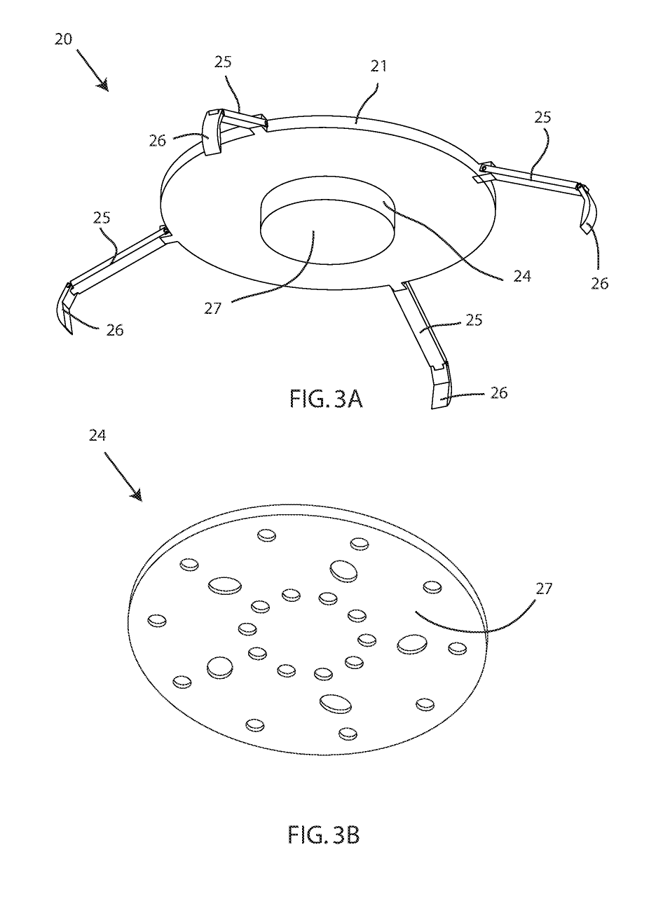

With continued reference to FIGS. 1 and 2, embodiments of the machine 100 may include a container engagement element 20. Embodiments of the container engagement element 20 may be an engagement mechanism, an engagement device, an engagement element, a paint can lid manipulator, a paint can manipulator, a paint can engagement element, a lid removing device, a claw device, a prying device, a container access element, and the like. Referring now to FIGS. 3A and 3B, embodiments of the container engagement element 20 may include one or more fingers 25. Embodiments of the one or more fingers 25 may be pivotable with respect to the base 21 of the container engagement element 20. For instance, each finger 25 may move up and down with respect to base 21. The fingers 25 may move in unison to clamp, claw, pinch, etc. to manipulate the container 5 or lid 6 of the container 5. Alternatively, the fingers 25 may be individual, discrete members capable of independent movement with respect to the other fingers 25. The fingers 25 may extend from the base 21 a distance sufficient to operably engage an outer circumference of the container 5. In other words, the fingers 25 may be sized and dimensioned such that the fingers 25 can engage an outer edge of the lid 6 of a container 5; the fingers 25 may be displaced radially inwardly and outwardly to match varying sizes of containers. Furthermore, embodiments of the container engagement element 20 may include engagement prongs 26 operably connected to the ends of the fingers 25. The engagement prongs 26 may be movably connected to the fingers 25. Embodiments of the engagement prongs may be prongs, teeth, curved fingers, and the like, configured to extend within a gap between the lid 6 and a top surface of the container 5. In an exemplary embodiment, the engagement prongs 26 may extend in a direction towards the base 21 of the container engagement element 20. The prongs 26 may form a right angle or an acute angle with respect to the fingers 25.

Moreover, embodiments of the container engagement element 20 may include a lid attachment mechanism 24. Embodiments of the lid attachment mechanism 24 may be operably coupled to an underside of the base 21 of the container engagement element 20. Embodiments of the lid attachment mechanism 24 may engage the lid 6 of the container 5 when the container engagement element 20 moves into the second position. Upon engagement, the lid attachment mechanism 24 may establish a removable connection with the lid 6 of the container 5, such that when the lid 6 has been disengaged from a connection, such as a sealed connection, with the container 5 by the engagement prongs 26, the lid 6 is lifted away from the container 5 as the paint engagement element 20 moves away from the container 5 and into or close to the first position. FIG. 3A depicts a first embodiment of the lid attachment mechanism 24, which may be a magnet configured to magnetically attach to the lid 6 to remove the lid 6. FIG. 3B depicts a second embodiment of the lid attachment mechanism 24, which may be a vacuum plate configured to secure the lid to remove the lid, using a suction force. The suction force may be supplied by a vacuum positioned within the housing 3.

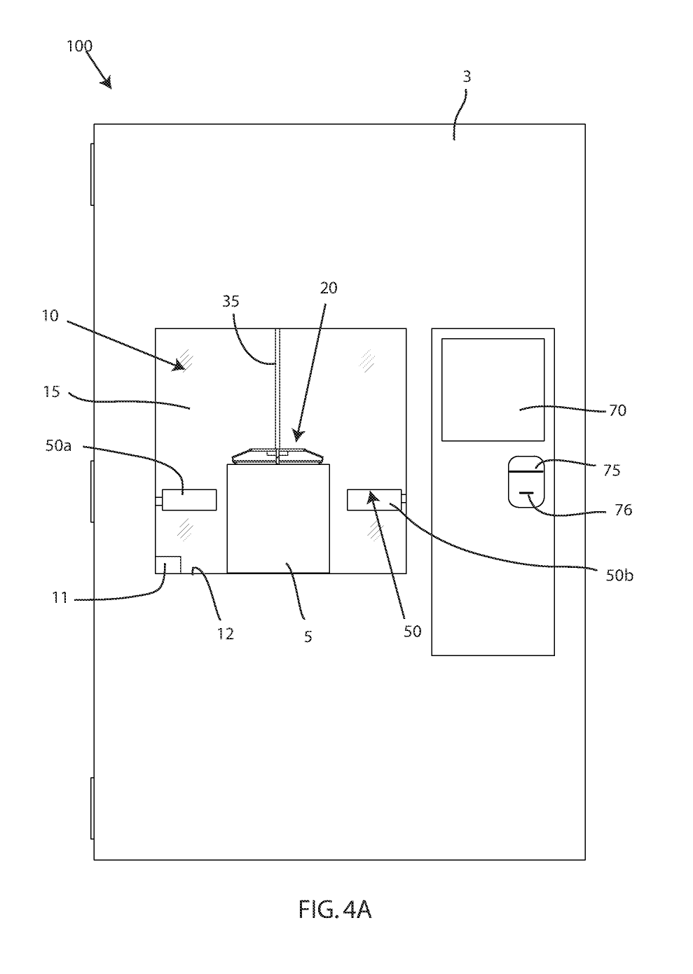

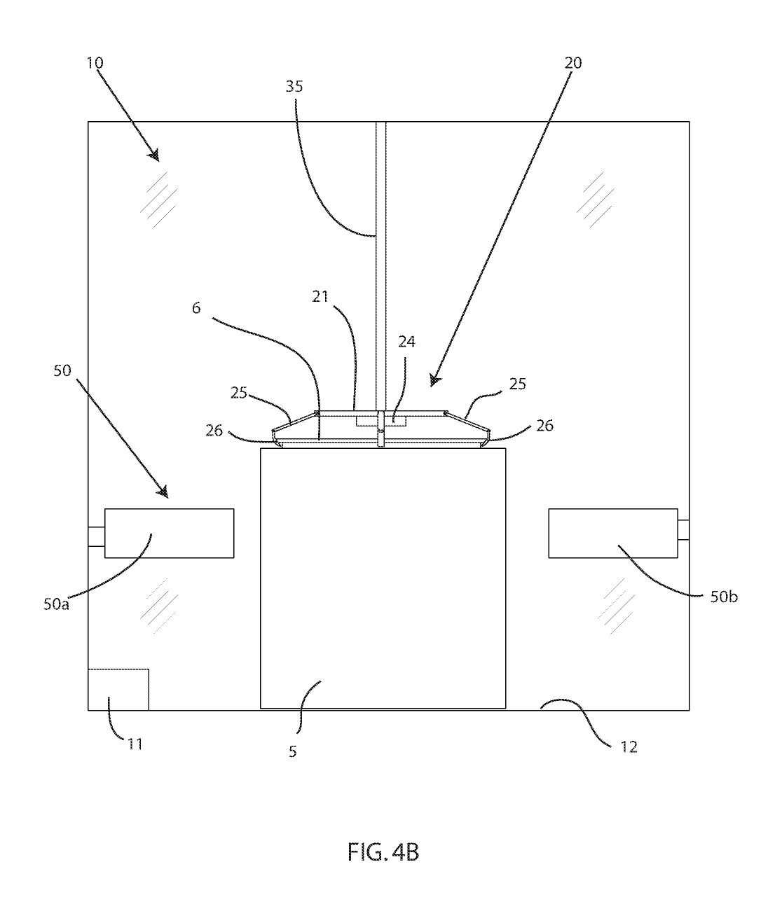

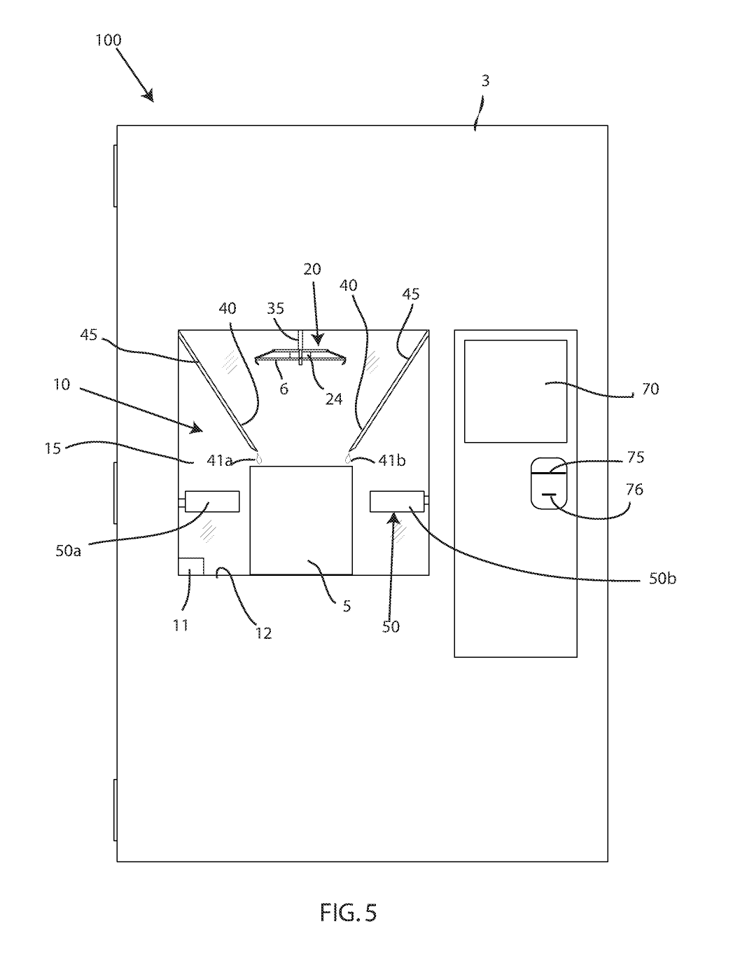

Referring now to FIGS. 4A and 4B, the container engagement element 20 may be configured to manipulate the container 5 and/or a lid 6 of the container. For example, embodiments of the container engagement element 20 may move from a first position to a second position to engage or otherwise manipulate a container 5 or lid 6 of the container 5. Moreover, the container engagement element 20 may be connected to an end effector or a structural component within the housing structure 3 of the machine 100. The container engagement element 20 may be operably coupled to the end effector or structural component at a position above the cabin 10. Embodiments of the container engagement element 20 may include an extension mechanism 35 that connects a base 21 of the container engagement element 20 to the structural component supporting the container engagement element 20 within the housing 3 of the machine 100. The extension mechanism 35 may be a connector, a rod, a cylinder, or other member that effectuates the movability of the container engagement element 20. In an exemplary embodiment, the extension mechanism 35 may be a telescoping element or retractable element, which cooperates with a motor or actuator connected to a computing system and/or microcontroller.

Accordingly, embodiments of the container engagement element 20 may descend towards the container 5 placed within the cabin 10, and may ascend away from the container 5 placed within the cabin 10. The container engagement element 20 may descend towards the container 5 to manipulate a lid 6 of the paint can 6. In an exemplary embodiment, the container engagement element 20 may move towards the container 5, wherein the fingers 25 and/or engagement prongs 26 engage the lid 6 of the container 5 (i.e. in the second position) to remove the lid 6 of the container 5 to allow a paint colorant to be dispensed into the container 5. For instance, the engagement prongs 26 may extend within the gap between the lid 6 and the top surface of the container 5, and pry or otherwise force the lid 6 to disengage from the container 5. To disengage the lid 6 from the container 5, the engagement prongs 26 may be moved in unison, or in succession around a circumference of the lid 6. Further, the fingers 25 may also be moved with the prongs 26 to deliver efficient and/or maximum force. In other embodiments, the fingers 25 and/or engagement prongs 26 may compress radially inwardly to effectuate a tight grip around the circumference of the lid 6, and the container engagement element may rotate to effectively twist off the lid 6. Twisting action may be effectuated by the end effector operably connected to the container engagement element 20, wherein the end effector may be rotatable about a Z axis.

In one embodiment, the lid 6 may rest on the inner surface of the prongs 26 as the container engagement element 20 moves away from the container 5. In another embodiment, the lid attachment mechanism 24 is moved into contact with the lid 6 such that an attachment surface 27 engages the lid to establish a removable or temporary connection with the lid 6. Thus, the lid ascends along with the container engagement element 20.

FIG. 5 depicts the container engagement element 20 moving into or towards a first position, away from the container 5, with the lid attached to the container engagement element 20. The container engagement element 20 may move a distance from the container 5 so that a plurality of dispensers 40 may dispense a combination of elements 41a, 41b (or single element) into the container 5 containing the base medium. Embodiments of the dispensers 40 of the machine 100 may include a dispenser, nozzle, valve, or similar applicator to dispense or otherwise deliver an amount of element to the base medium needed to arrive at the desired mixed product selected by the user. In an exemplary embodiment, the dispensers 40 of the machine 100 may be paint colorant dispensers for dispensing or otherwise delivering an amount of paint colorant to the base paint needed to arrive at the desired paint color and finish selected by the user. In further embodiments, the dispensers 40 may be a dispenser, nozzle, valve, or similar applicator to dispense or otherwise deliver an element(s) such as an ingredient, a flavoring agent, sugar, egg wash, cream, a topping, a coloring agent, a foodstuff, compressed air, a gas, a colorant, a pigment, a finishing agent, a dye, and a combination thereof.

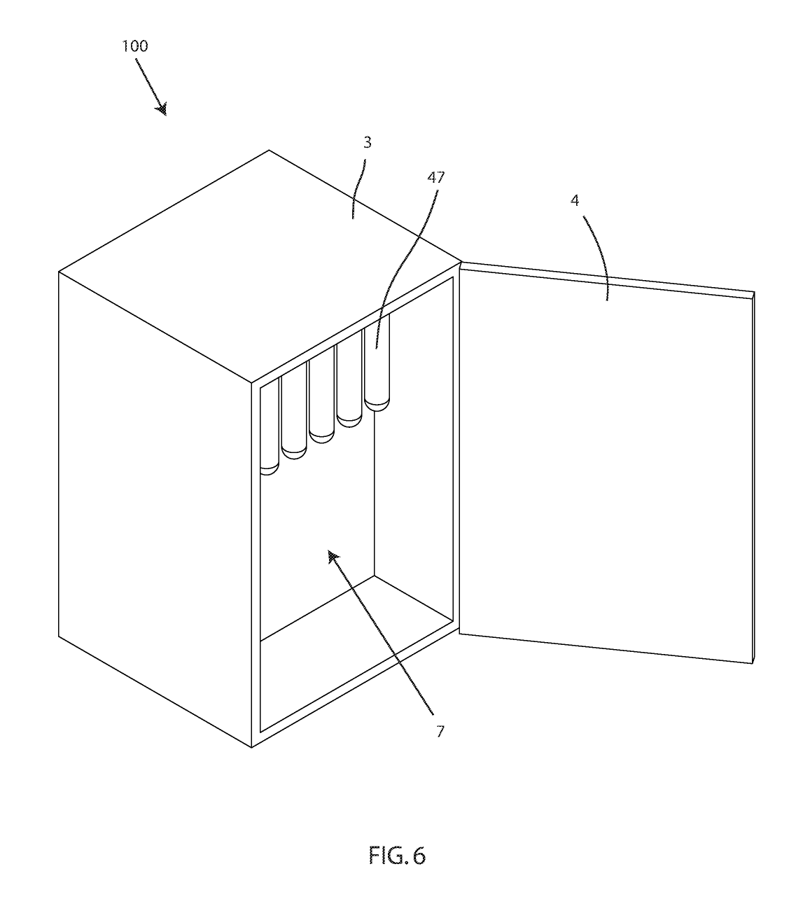

Embodiments of the dispensers 40 may be connected to an end effector or a structural component within the housing structure 3 of the machine 100. The dispensers 40 may be operably coupled to the end effector or structural component at a position above the cabin 10. Embodiments of the dispensers 40 may include an extension mechanism 45 that connects a dispenser to the structural component supporting the dispensers 40 within the housing 3 of the machine 100. The extension mechanism 45 may be a connector, a rod, a cylinder, or other member that effectuates the movability of the dispensers 40. In an exemplary embodiment, the extension mechanism 45 may be a telescoping element or retractable element, which cooperates with a motor or actuator connected to a computing system and/or microcontroller. Further, supply lines connected to one or more supplies of elements (e.g. paint colorant, flavoring agents, etc.) may be attached to the extension mechanism 45 or may be disposed within a hollow conduit formed by the extension mechanism 45. FIG. 6 depicts a rear view of the machine 100 that may store or otherwise contain a plurality of supply tanks 47. The supply tanks 45 may be reservoirs, tanks, canisters, containers, and the like, capable of delivering elements to the dispenser 40 under pressure. For instance, embodiments of the supply tanks 47 may store egg wash, flavoring agents, paint colorants, coloring agents, chemicals, foodstuffs, and the like, for mixing with the base medium to create a mixed product selected by the user of the machine 100. The machine 100 may include an access door 4 that may be opened to access an interior of the machine 100 to service the components of the machine 100 and/or replace/refill the supply tanks 47.

The combination of elements (e.g. a paint colorant combination) dispensed into the container 5 by the plurality of dispensers 40 may be determined by the computer system associated with the machine 100. For instance, the dispensers 40 may dispense a paint colorant 41a, 41b into the container 5 according to a paint colorant combination corresponding to the selected paint color, as determined by the computing system. The computing system or other microcontroller may control one or more flow regulators or valves to control a flow of paint colorant through the dispenser 40. In another embodiment, the dispensers 40 may dispense a flavoring agent and sugar 41a, 41b into the container 5 according to a combination corresponding to a selected beverage, as determined by the computing system. The computing system or other microcontroller may control one or more flow regulators or valves to control a flow of flavoring agent through the dispenser 40. In yet another embodiment, the dispensers 40 may dispense a foodstuff 41a, 41b into a broth inside the container 5 according to an ingredient combination corresponding to the selected soup, as determined by the computing system. The computing system or other microcontroller may control one or more flow regulators or valves to control a flow of foodstuffs through the dispenser 40.

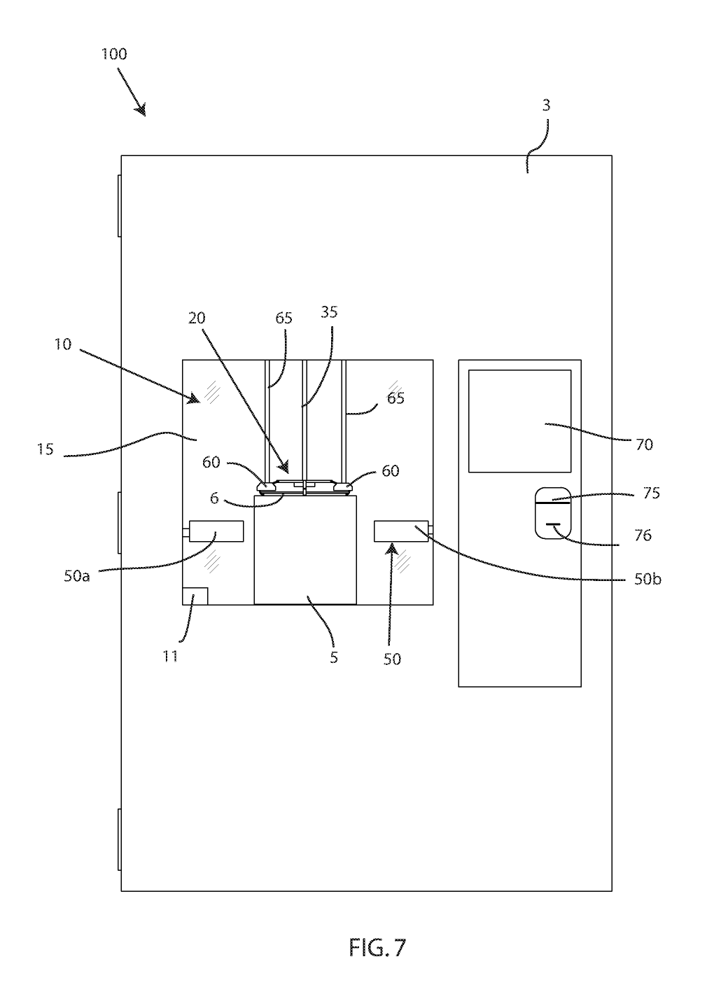

With reference now to FIG. 7, after one or more elements are dispensed into the container 5, the plurality of dispensers 40 may retract away from the container 5, and the container engagement element 20 may descend or otherwise move toward the container 5, with the lid 6 attached thereto. The container engagement element 20 may align the lid 6 such that the lid 6 is place into position on the container 5. When the lid 6 is placed into position, the removable connection between the lid 6 and the lid attachment mechanism 24 may be severed. To secure lid 6 back onto the container 5 so that the finished product inside the container 5 is sealed or otherwise covered in a secure manner for transportation, one or more lid sealing elements 60 may engage the lid 6 proximate or otherwise near the edge of the lid to drive the lid 6 back into engagement or sealing engagement with the container 5. The engagement between the lid sealing elements 60 may be a hammering effect (e.g. up and down repeatedly for a given duration) or may be a single downward drive. Embodiments of the lid sealing elements 60 may include a rubber component to protect the machine component, as well as protect the container 5 from damage. Alternatively, the lid sealing element 60 may be comprised of an elastomeric material at an end of the extension mechanism 65. The lid sealing elements 60 may also be referred to as a foot or a rubber foot, such that a larger surface area makes impact into the lid 6 for a more efficient sealing operation or lid closing operation.

Further, lid sealing element(s) 60 may be connected to an end effector or a structural component within the housing structure 3 of the machine 100. The lid sealing elements 60 may be operably coupled to the end effector or structural component at a position above the cabin 10. Embodiments of the lid sealing elements 60 may include an extension mechanism 65 that connects a lid sealing element 60 to the structural component supporting the lid sealing element 60 within the housing 3 of the machine 100. The extension mechanism 65 may be a connector, a rod, a cylinder, or other member that effectuates the movability of the lid sealing elements 60. In an exemplary embodiment, the extension mechanism 65 may be a telescoping element or retractable element, which cooperates with a motor or actuator connected to a computing system and/or microcontroller, to deliver a hammering force to seal the lid 6 of the container 5.

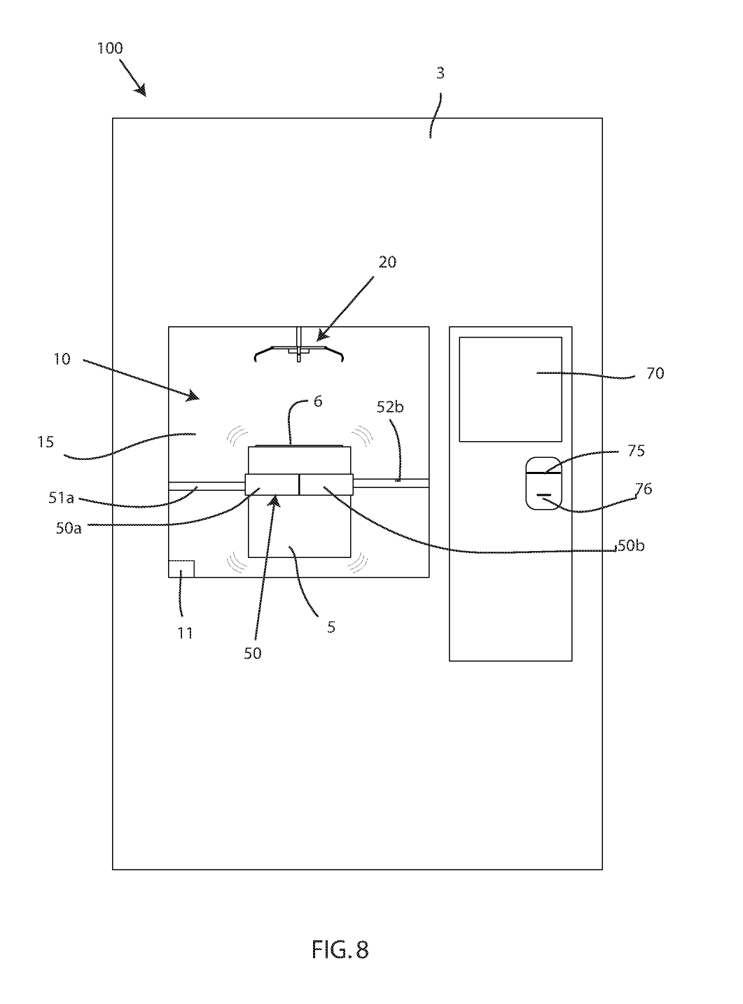

In response to the lid 6 being replaced and/or sealed back onto the container 5, the machine 100 may mix the contents (e.g. paint base and added paint colorant combination, or coffee and cream, or flour, yeast, and egg wash, etc.). Embodiments of the machine 100 may include a mixing mechanism 50 to manipulate the container 5 in a way to satisfactorily mix the contents within the container 5. FIG. 8 depicts an embodiment of the automated selecting and mixing machine 100 being mixed by a first embodiment of a mixing mechanism 50. A first embodiment of the mixing mechanism 50 may include a first gripping device 50a and a second gripping device 50b configured to grip, grab, secure, stabilize, clamp, seize, etc., the container 5. The gripping devices 50a, 50b may include a curved component that matches or corresponds to a curvature or partial circumference of the container 5, or a general outer shape of the container 5 (e.g. square, rectangular, or otherwise non-circular shaped containers). The gripping devices 50a, 50b may be operably coupled to an end effector or structural component at a position to each side of the cabin 10. Embodiments of the gripping devices 50a, 50b may include an extension mechanism 51a, 51b, respectively, that connects a gripping device 50a, 50b to the structural component supporting the gripping devices 50a, 50b within the housing 3 of the machine 100. The extension mechanisms 51a, 51b may be a connector, a rod, a cylinder, or other member that effectuates the movability of the gripping devices 50a, 50b. In an exemplary embodiment, the extension mechanism 51a, 51b may be a telescoping element or retractable element, which cooperates with a motor or actuator connected to a computing system and/or microcontroller, to cause the gripping devices 50a, 50b to move towards and away from the container 5 in the cabin 10. For instance, the first gripping device 50a may extend from a first side of the cabin 10 and engage the container 5, while the second gripping device 50b may extend from an opposing second side of the cabin 10 to engage the container 5. The gripping devices 50a, 50b may secure the container 5 using an axial force exerted from both side of the container 5 by the gripping devices 50a, 50b. Alternatively, each gripping device 50a, 50b may have a clamping functionality, whereby the components disposed at an end of the extension mechanism 51a, 51b compress inwardly to exert a compressive, gripping force against the sides of the container 5. Once the container 5 is gripped, secured, stabilized, seized, etc., by the gripping devices 50a, 50b, the gripping devices 50a, 50b may mix the contents in the container 5 by manipulating the container 5. For example, the mixing mechanism 50 (e.g. gripping devices 50a, 50b and extension mechanisms 51, 51b) may shake, rotate, invert, lift, or otherwise displace the container 5 in multiple directions to disrupt, mix, shake, displace, etc. the contents within the container 5 to result in a homogenous, partially homogenous, or non-homogenous mixture inside the container 5. The duration of the mixing process may be programmable and predetermined based on the element combination, base medium, size of container 5, combinations thereof, and the like. For example, duration of the mixing process may be programmable and predetermined based on a paint colorant combination, base paint, selected desired color, size of container 5, combinations thereof, and the like.

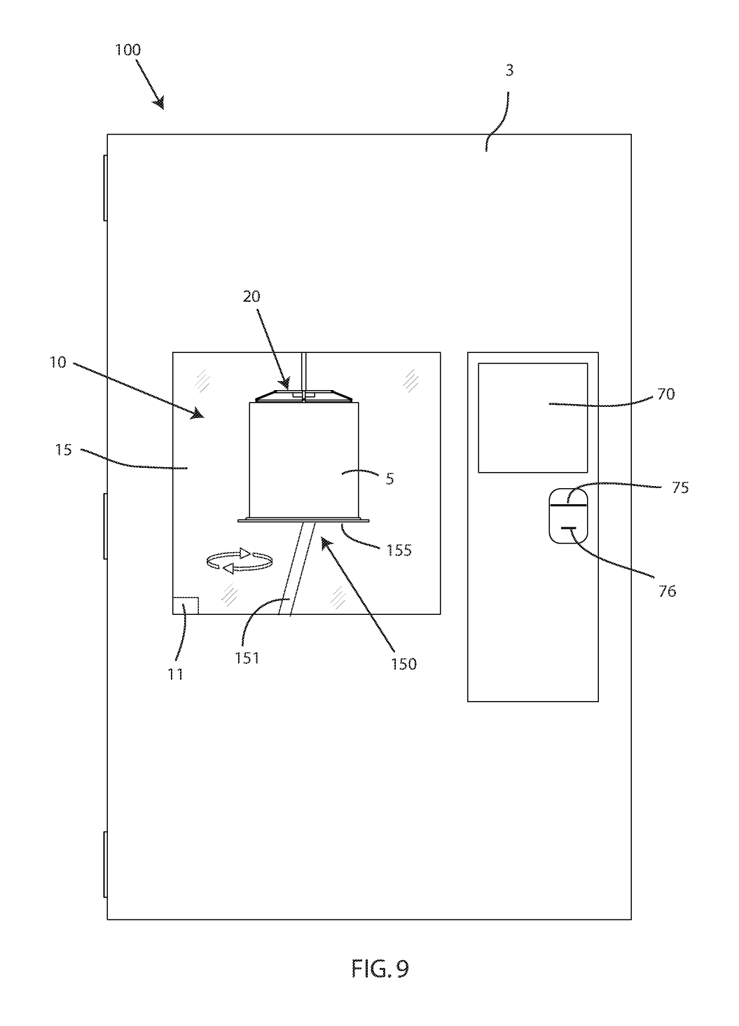

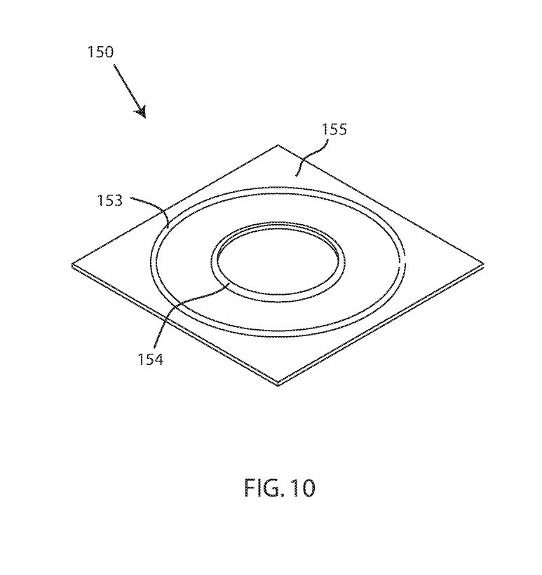

FIG. 9 depicts an embodiment of the automated selecting and mixing machine 100 being mixed by a second embodiment of a mixing mechanism 150. A second embodiment of the mixing mechanism 150 may include a moveable platform 155 and a platform controlling element 151. Embodiments of the moveable platform 155 may be a surface configured to accept, accommodate, receive, etc. the container 5 within the cabin 10. In an exemplary embodiment, the movable platform 155 comprises the floor surface 12, or a portion thereof, of the cabin 10. The container 5 may be placed initially on the movable platform 155 at the beginning of the automated process carried out by machine 100. FIG. 10 depicts a perspective view of an embodiment of a movable platform 155 of the second embodiment of the mixing mechanism 150. Embodiments of the movable platform 155 may include a first lip 153 and a second lip 154. Embodiments of the first lip 153 and the second lip 154 may be an annular lip, an edge, an annular edge, a rim, a wall, and the like, and may have various cross-sections, such as square, rectangular, circular, or other curvilinear. The lips 153, 154 may protrude a distance from a surface of the movable platform 155 to prevent or hinder against a translational movement of the container 5 on the movable platform 155 during the automated process. Further, the lips 153, 154 may be spaced apart to accommodate various sizes of the container 5.

Referring still to FIGS. 9-10, embodiments of the mixing mechanism 150 may include a platform controlling element 151, which may manipulate or otherwise control a movement of the platform 155. The platform 155 may be operably coupled to an end effector or structural component at a position beneath the cabin 10. Embodiments of the platform controlling element 151 may connect the platform 155 to the structural component supporting the platform 155 within the housing 3 of the machine 100. The platform controlling element 151 may be a connector, a rod, a cylinder, or other member that effectuates the movability of the movable platform 155. In an exemplary embodiment, the platform controlling element 151 may be a telescoping element or retractable element, which cooperates with a motor or actuator connected to a computing system and/or microcontroller, to cause a movement of the movable platform 155. The platform controlling element 155 may manipulate, move, rotate, shake, lift, lower, or otherwise cause the moveable platform 155 to displace in one or more directions to disrupt, mix, shake, displace, etc. the contents within the container 5 to result in a homogenous, partially homogenous, or non-homogenous mixture inside the container 5. The duration of the mixing process may be programmable and predetermined as described above. In an exemplary embodiment, the container engagement element 20 may be brought into contact with a top surface of the container 5 to further stabilize the container 5 on the movable platform 155 during the mixing process. Accordingly, the container 5 may be secured between the container engagement element 20 and the platform 155, which is in addition to the engagement between the container 5 and the lips 153, 154, to help stabilize the container 5 during the mixing process.

In an exemplary embodiment, the machine 100 may employ the first embodiment of the mixing mechanism 50 to mix the contents, yet still include a platform similar to movable platform 155. For example, the platform, which may comprise a bottom surface 12 of the cabin 10, may include lips similar to the lips 153, 154 to prevent or hinder translational movement of the container 5 during various steps of the automated process. Thus, the platform embodiment may be static in embodiments of the machine 100 using a first embodiment of the mixing mechanism 50, but provide additional support to the container 5 placed within the cabin 10.

When the mixing process has completed, the mixing mechanism 50, 150 may cease moving and return to an original position within the cabin 10. For instance, in a first embodiment, the gripping devices 50a, 50b may retract away from the container 5, thereby releasing the container 5. In a second embodiment, the movable platform 155 may return to an original position, and cease movement. The one or more sensors 11 located within the cabin 10 may detect that the mixing mechanism 50, 150 has returned to an original position, and/or that the components of the machine 100 within the cabin 10 are not moving. In response to detecting that the cabin 10 is safe for a user to reach inside and retrieve the container 5, the access element 15 may open, allowing access to the container 5, so that the user may retrieve the container 5 with the final mixed product as selected by the user using the user interface 70.

Referring back to FIG. 1, embodiments of the machine 100 may include a user interface 70. Embodiments of the user interface may be a graphical user interface (GUI). The user interface may be a display, a touchscreen, a computer screen, a terminal, an interactive display, and the like, which may display/provide information for selecting a product. The user interface 70 may be used by the user to browse paint options, such as various colors, brands, finishes, color combinations, palettes, etc., various flavors for a beverage, colors for a woodstain, types of soups, types of ice creams, coffee options, and the like. In an exemplary embodiment, the user may interact with the user interface 70 to browse and select a desired paint from a number of available options, as well as input various data regarding the user's paint needs (e.g. type of room to be painted, size of the room, preferred color(s), etc.). The user interface 70 may process the user inputs to provide information or suggestions to the user for selecting a paint color. Moreover, embodiments of the machine 100 may include a scanner 76 for scanning a paint swatch to display one or more paint color suggestions relating to the paint swatch. The paint swatches may be printed papers having one or more colors printed thereon, wherein the paint swatch may include a unique identifier configured to communicate data regarding the paint colors to the user interface 70. Based on the received information from the scanner 76, the user interface 70 may display the scanned colors or provide suggestions relating to the scanned paint swatches.

Once the user has decided on a particular product, the user may select the one or more options pertaining to a final product (e.g. a paint color) using the user interface 70, and the user interface 70 may provide instructions on the automated process, as well as which container 5 to retrieve from the salesfloor for use with the machine 100. The machine 100 may print out a paper receipt or paper instructions including the base medium information, via slot 75 coupled to the machine 70. When the user is ready to use machine 100, the user may interact with the user interface 70 to initiate the automated process of the machine 70. For example, the user may select a “START” button, which may open access element 15 to allow the user to place the container 5 containing a base medium composition, wherein the access element 15 is closed upon detection that the cabin 10 is free of hands, foreign objects, and that the container 5 is properly inserted into the cabin 10. Alternatively, the access element 15 may be open, allowing the user to place the container 5 inside the cabin 10, and then the user may select a “START” button to initiate the automated process of the machine 100. The user interface 70 may generate a receipt for payment, which may be printed and provided to the user through the slot 75. The receipt may be presented at a checkout lane for payment. The receipt may also include paint color details, as well as a photograph or other color image corresponding to the paint color, which may be placed onto the container 5. Alternatively, the user interface 70 may print out a separate sticker with paint color details and color image of the paint color, which may be adhered to the container 5.

Embodiments of the user interface 70 may also allow a user to “log-in” so that the machine 100 may receive or otherwise have knowledge of user preferences, user saved payment instruments (i.e. credit card, debit cards, e-gift cards, etc.), saved “favorites”, frequently purchased paint colors, soups, coffees, beverages, dough, and the like. For instance, the user may enter a username and password into the user interface 70, which is operably connected to the computing system associated with the machine 100. In other embodiments, the user interface 70 may access or communicate with a mobile device of the user, which may have user-related information stored thereon, or servers servicing relevant mobile applications running on the user's mobile device. In instances where a user is linked to the user interface 70 of the machine 100 (e.g. logged in), the user interface 70 may authenticate the user, prior to retrieving or displaying any user-related information. In at least one embodiment, the machine 100 may not initiate system components until the user interface 70 authenticates the user. Embodiments of the machine 100 may include a biometric identifier to authenticate a user. Embodiments of a biometric identifier may include a fingerprint scanner, a retina scanner, a facial recognition camera, a voice signature detector, or similar device that can authenticate a user using a biometric of the user. In some embodiments, the biometric identifier may be a button (physical or touchscreen) that sends a request to the user's mobile device to authenticate the user. For instance, activating the biometric identifier may send a request to a user's mobile phone to prompt the user to authenticate the user by pressing the user's fingerprint on a fingerprint or other biometric scanner that is a hardware component of the user's mobile device.

Referring now to FIGS. 1-10, a method for automating a mixing process, may include the steps of initiating the mixing process in response to a user selecting a final product from a user interface 70, removing a lid 6 of a container 5 placed within a cabin 10 of a mixing machine 100 by the user, wherein a container engagement element 20 having one or more fingers 25 engages the lid 6 of the container 5 to remove the lid 6, further wherein the lid 6 is temporarily attached to the container engagement element 20 as the container engagement element 20 retracts away from the container 5, dispensing an element or combination of elements 41a, 41b into the container 5 using a plurality of dispensers 40, according to a combination corresponding to the selected final product, and mixing a base medium and the element(s). The method for automating a mixing process may be a method for automating a mixing process to make foodstuffs, such as ice cream, dough, soups, beverages, cake mix, etc., as well as a woodstain, solution, oil, etc.

Furthermore, a method for automating a paint mixing process, may include the steps of initiating the paint mixing process in response to a user selecting a paint color from a user interface 70, removing a lid 6 of a container 5 placed within a cabin 10 of a paint mixing machine 100 by the user, wherein a container engagement element 20 having one or more fingers 25 engages the lid 6 of the container 5 to remove the lid 6, further wherein the lid 6 is temporarily attached to the container engagement element 20 as the paint can engagement element retracts away from the container 5, dispensing a paint colorant 41a, 41b into the container 5 using a plurality of paint colorant dispensers 40, according to a paint colorant combination corresponding to the selected paint color, and mixing a base paint and the paint colorant.

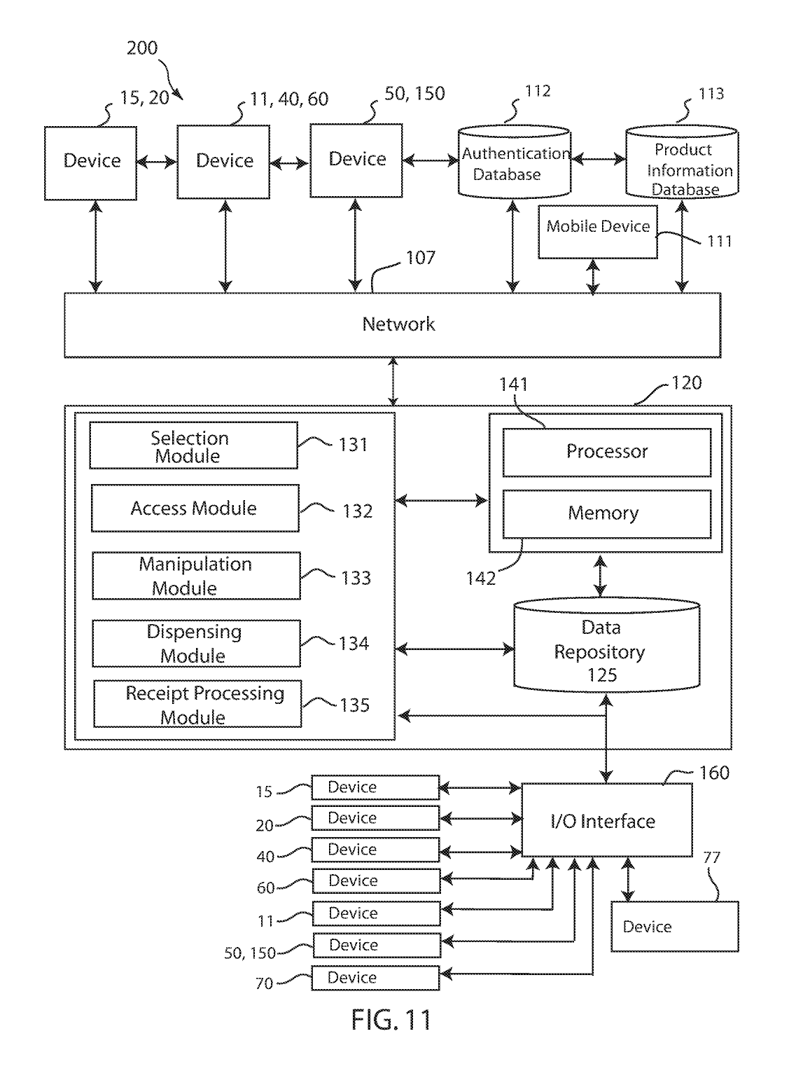

Referring still to the drawings, FIG. 11 depicts a block diagram of an embodiment of a selecting and mixing system 200. Embodiments of the selecting and mixing system 200 may comprise one or more devices 15, 11, 20, 40, 60, 50, 150, 70, 77 communicatively coupled to a computing system 120 via an I/O interface 160 and/or over a network 107. For instance, some or all of the devices 15, 11, 20, 40, 60, 50, 150, 70, 77 may be connected via an I/O interface 160 to computer system 120. Embodiments of the computing system 120 may be a computer located within the housing 3 of the machine 100, or may be a computing system coupled to the machine 100. The number of devices connecting to computer system 120 may be connected via data bus lines and/or over network 107 may vary from embodiment to embodiment, depending on the number of devices present in the paint selecting and mixing system 200.

As shown in FIG. 11, a number of devices 15, 11, 20, 40, 60, 50, 150, 70, 77 may transmit data to or receive instructions from the computing system 120 by connecting to computing system 120 via data bus lines to an I/O interface 160. An I/O interface 160 may refer to any communication process performed between the computer system 120 and the environment outside of the computer system 120, for example, the input devices 15, 11, 20, 40, 60, 50, 150, 70, 77. Input to the computing system 120 may refer to the signals or data sent to the computing system 120, such as data regarding a positioning of the container 5 within the cabin 10, while output may refer to the signals or instructions sent out from the computer system 120, such as an actuation signal to the actuator for opening and closing the access element 15, or instruction signals sent to the container engagement element 20 for manipulating the lid 6 of the paint can.

Some or all of the devices 15, 11, 20, 40, 60, 50, 150, 70, 77 may transmit data or receive instructions by connecting to computing system 120 over the network 107. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computer system 120, and devices 15, 11, 20, 40, 60, 50, 150, 70, 77, a connection to one or more network accessible knowledge bases containing information of one or more users, network repositories or other systems connected to the network 107 that may be considered nodes of the network 107. In some embodiments, where the computing system 120 or network repositories allocate resources to be used by the other nodes of the network 107, the computer system 120 and network repository may be referred to as servers.

The network repository may be a data collection area on the network 107 which may back up and save all the data transmitted back and forth between the nodes of the network 107. For example, the network repository may be a data center saving and cataloging user's transactions and purchase history and preferences to generate both historical and predictive reports regarding a particular user or a particular user's purchases. In some embodiments, a data collection center housing the network repository may include an analytic module capable of analyzing each piece of data being stored by the network repository. Further, the computer system 120 may be integrated with or as a part of the data collection center housing the network repository. In some alternative embodiments, the network repository may be a local repository that is connected to the computer system 120.

Referring still to FIG. 11, embodiments of the devices 15, 11, 20, 40, 60, 50, 150, 70, 77 may be positioned on the machine 100, within the housing structure 3 of the machine 100, or remotely from the machine 100. The devices 15, 11, 20, 40, 60, 50, 150, 70, 77 may be a sensor, an input device, an input mechanism, or a component of the machine. The devices may include access element 15, sensor 11, container engagement element 20, dispenser 40, lid sealing element 60, a mixing mechanism 50, 150, user interface 70, and receipt generator and printer 77.

Embodiments of the computer system 120 may be equipped with a memory device 142 which may store the various user information, transactions, product information, mobile payment account information, and the like, and a processor 141 for implementing the tasks associated with the selecting and mixing machine 200.

Embodiments of computer system 120 may include a selection module 131, an access module 132, a manipulation module 133, a dispensing module 134, and a receipt processing module 135. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the selection module 131 may include one or more components of hardware and/or software program code for receiving a selection from the user operating the user interface 70, the selection including a desired paint color, a flavor, or other final product to be mixed. For example, the selection module 131 may obtain or receive a selection of a desired paint color to be mixed by the machine 100. The selection module 131 may also provide various options and product information regarding available paint colors, flavors, finishes, etc. For instance, the selection module 131 may query or access one or more databases, such as a product information database 113. Embodiments of the product information database 113 may store information regarding available paint colors, suggested colors, product information, inventory information, ingredients, recipes, and the like. The product information database 113 may be accessed in response to the user scanning a paint swatch or other bar code relating to product for purchase, such as a paint color or catalogue of paint colors (e.g. paint color samples provided by vendors).

Moreover, embodiments of the selection module 131 may authenticate a user, in response to a user logging in via the user interface 70. The selection module 131 may query or access an authentication database 112 to authenticate a user logging into the system, or a user of a mobile device 111 that is attempting to pair/communicate with the computing system 120 of the machine 100. Embodiments of the authentication database 112 may be one or more databases, storage devices, repositories, and the like, that may store or otherwise contain information and/or data regarding personal account information of a user, such as name, account identifiers, passwords, pin numbers, address information, other personal identifying information and the like, that may be associated with a mobile application on the mobile device 111 of the user. The customer authentication database 112 may be accessed over network 107, and may be managed and/or controlled by a third party, or by a retailer associated with the mobile application on the user's mobile device 111. Embodiments of the selection module 131 may retrieve, receive, obtain, derive, etc. authenticating information from the customer authentication database 112. For instance, the identification module 131 may query the customer authentication database 112 to identify a user that has submitted identifying information via the user interface 70 or a biometric identifier, or has used a mobile device 111 to transmit a communication to the computing system 120 of the machine 100 as part of a paring or linking process between the user and the machine 100. Once an identity is established by the selection module 131, the selection module 131 may request that the identity be confirmed by the user using one of the methods not used to initially establish identity. For instance, if the user entered a login and password into the user interface 70, the selection module 131 may request that the user submit a fingerprint via the biometric identifier (or fingerprint sensor on the user's mobile device), or may request that the user enter a pin number in response to a request sent to the mobile device 111 from the selection module 131.

In addition, the selection module 131 may further use payment account information to authenticate the user. For example, the selection module 131 may query one or more databases, such as a payment accounts database to further confirm or authenticate the user. Embodiments of the payment accounts database may be one or more databases, storage devices, repositories, and the like, that may store or otherwise contain information and/or data regarding one or more payment instruments associated with the user and the user's mobile application on the mobile device 111. The payment accounts database may also be accessed over network 107, and may be affiliated with, managed, and/or controlled by one or more financial institutions, issuers, authorizers, and the like. Embodiments of the selection module 131 may query the payment accounts database to identify a user based on one or more payment instruments associated with the user. Payment instruments may be a bank account, a credit card account, a debit card, a checking account, an electronic gift card, and the like. Embodiments of the selection module 131 may retrieve or otherwise receive payment instrument information stored on the mobile device 111 or stored on a remote server servicing the mobile device 111, and may compare the information to authenticate the user. In some embodiments, the selection module 131 may not need to authenticate a user, and process the user's selection as a guest. In other embodiments, the selection module 131 may process a log-in of the user via the user interface 70, without authenticating the user. Authentication may be performed or not depending on the location of the machine 100, or other parameters.

Embodiments of the computing system 120 of the selecting and mixing system 200 may also include an access module 132. Embodiments of the access module 132 may include one or more components of hardware and/or software program code for controlling access to a cabin 10 of the machine 100 to accept a container 5 from a user to perform the automated process. For example, the access module 132 may receive a signal from the sensor 11, which may contain information confirming that the cabin 10 can safely be closed. In response to receiving the signal from the sensor 11, the access module 132 may transmit an actuation signal to an actuator associated with the access element 15 to release, drive, or otherwise displace the access element 15 to close the access element 15. Once the automated process is completed, the access module 132 may open the access element 15 so that a user may retrieve the container 5.

With continued reference to FIG. 11, embodiments of the computing system 120 of the selecting and mixing system 200 may include a manipulation module 133. Embodiments of the manipulation module 133 may include one or more components of hardware and/or software program code for manipulating the container 5 disposed within the cabin 10 of the machine. For instance, embodiments of the manipulation module 133 may send instructions or signals to the components of the machine 100 that may remove the lid 6 of the container 5, dispense elements into the container 5, replace and seal the lid 6 of the container 5, and mix the container 5. The instructions or signals may be sent from the manipulation module 133 to the container engagement element 20, dispensers 40, lid sealing element 60, and mixing mechanism 50, 150 to carry out the automated process, in a manner as described above.

Embodiments of the computing system 120 of the machine 100 may also include a dispensing module 134. Embodiments of the dispensing module 134 may include one or more components of hardware and/or software program code for determining a combination of elements (or a single element) to be dispensed into the container 5. For example, the dispensing module 134 may determine what dyes need to be dispensed into the base paint to achieve the desired color selected by the user. Further, the dispensing module 134 may also determine an amount of each elements, such as a dye, to be dispensed into the base medium to achieve the desired final product, such as a paint color selected by the user. Embodiments of the dispensing module 134 may also control the flow of the element, such as a paint colorant, through the dispensers 40, for example, controlling one or more flow regulators, valves, and pumps. The dispensing module 134 may access the product information database 113 to acquire necessary element combination information, or may access data repository 125, which may store element combination information (e.g. pain colorant combination information, recipes, suspension/solvent/dye ratios, etc.).

Embodiments of the computing system 120 associated with the machine 100 may include a receipt processing module 135. Embodiments of the receipt processing module 135 may include one or more components of hardware and/or software program code for generating and printing a receipt for purchase of the container 5. For instance, embodiments of the receipt processing module 135 may instruct the receipt printer 77 to print out a receipt and deliver the receipt to the user via slot 75 located on the housing 3 of the machine 100. The receipt may include information needed to process payment at a checkout lane. The receipt may also include information regarding the purchased final product.

In other embodiments, the receipt processing module 135 may include one or more components of hardware and/or software program code for facilitating a transaction for the container 5. For instance, embodiments of the receipt processing module 135 may receive payment information from the user interface 70, when the user uses physically interacts with the user interface 70 (or a payment processing device, such as credit card machine). In response to receiving the payment information, the receipt processing module 135 may transmit the payment information to another server or servers that facilitate monetary transaction. In other words, the receipt processing module 135 may instruct a payment processing application operated on a different (or same) server that can effectuate a monetary transaction, as known to those skilled in the art. In alternative embodiments, the user may not need to physically interact with a payment processing device or user interface 70 at a payment step, but may rely on contactless payment methods, wherein a “digital wallet” application on the user's mobile device 111 may communicate with the receipt processing module 135 (to receive the total bill, etc.) and complete the transaction.

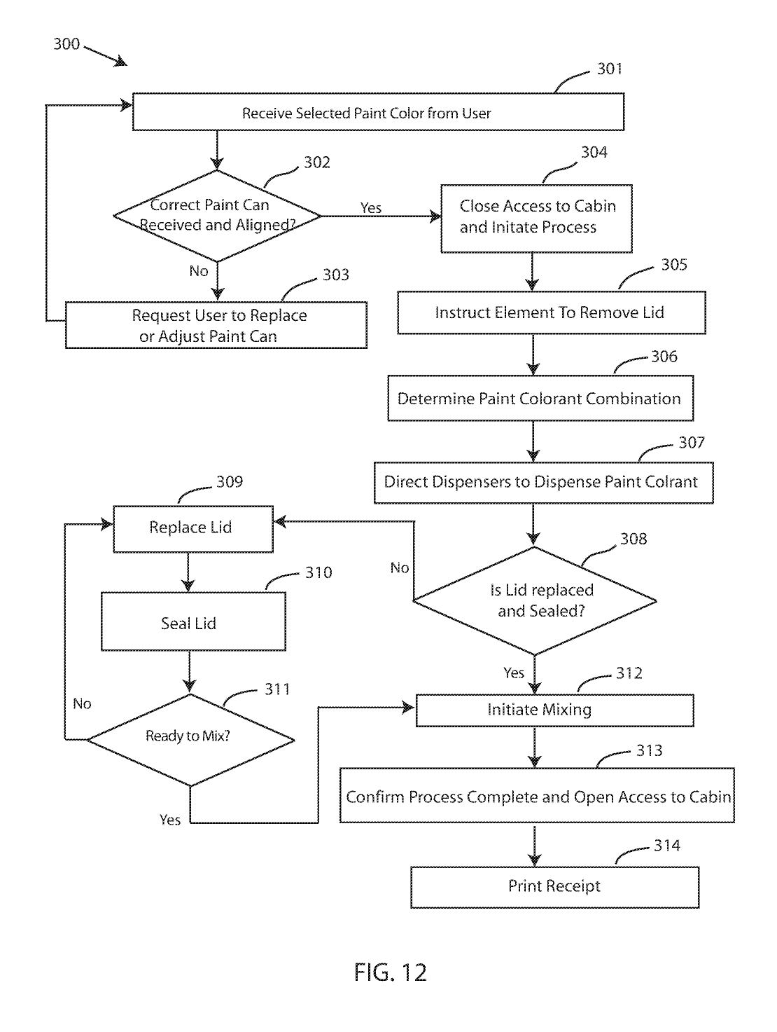

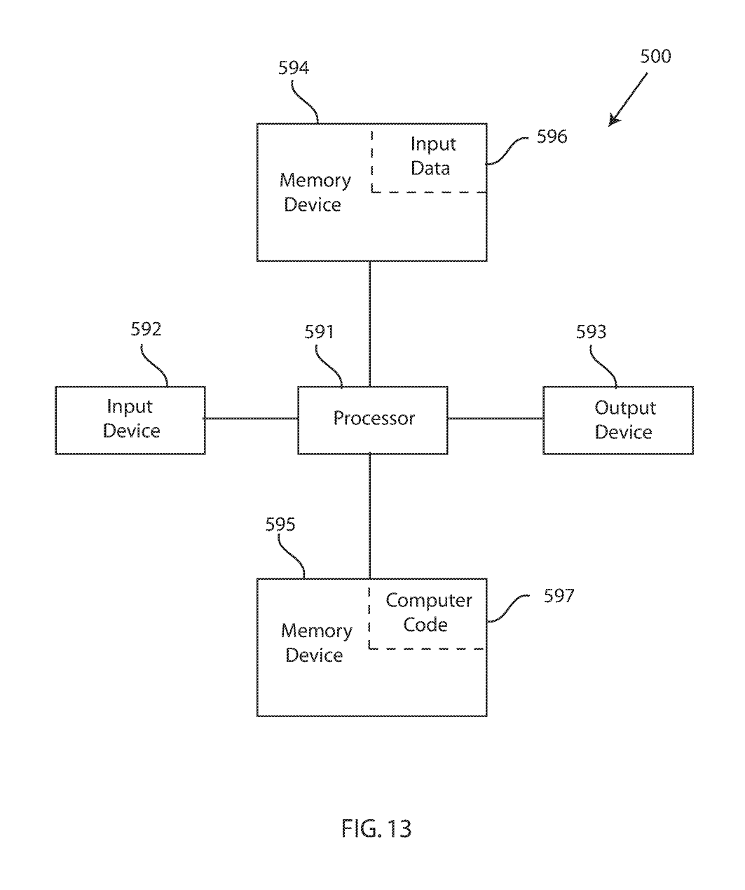

Referring now to FIG. 12, which depicts a flow chart of an embodiment of a method 300 for paint selecting and mixing. While this flow chart is depicted with respect to paint selecting and mixing, the steps may be performed the same way or substantially the same way for other final products selecting and mixing. One embodiment of a method 300 or algorithm that may be implemented for automated paint selecting and mixing using machine 100 in accordance with the selecting and mixing system 200 described in FIG. 11, using one or more computer systems as defined generically in FIG. 13 below, and more specifically by the specific embodiments of FIG. 11.

Embodiments of the method 300 for automated paint selecting and mixing may begin at step 301 wherein a selected paint color is received from the user. The user may input the user's selection via user interface 70. After making a selection, the user may place a paint can in the cabin 10 of the machine 100. Step 302 determines whether the correct container 5 has been inserted into the cabin 10, and/or whether the container 5 is properly aligned inside the cabin 10. If the container 5 is incorrect, and/or not properly aligned, step 303 requests, via user interface 70, the user to replace and/or adjust the container 5. If the container 5 is correct and properly aligned, step 304 closes an access element 15 initiates the automated process. In some embodiments, step 304 may first prompt the user to press a “START” button in response to a prompt on the user interface 70 that the process is ready to get started. Step 305 instructs a container engagement element 20 to remove a lid 6 of the container 5 inside the cabin 10. Step 306 determines a paint colorant combination to dispense into the paint to achieve the desired color selected by the user. The step of determining may occur prior to lid removal. Step 307 instructs/directs the paint colorant dispensers 40 to dispense the paint colorant 41a, 41b into the container 5, in accordance with the determined paint colorant combination. Step 308 determines whether the lid 6 of the container 5 has been replaced and sealed. If the lid needs to be replaced and sealed, step 309 replaces lid, for example by instructing container engagement element 20 to replace the lid 6 onto the container 5. Then step 310 seals lid, for example by instructing one or more lid sealing elements 60 to seal the lid 6 onto the container 5. Step 311 determines whether the container 5 is ready to mix, after steps 309 and 310. If the lid is replaced and sealed at step 308, then the method continues directly to step 312. Step 312 initiates mixing of the container 5, for example, by instructing a mixing mechanism 50, 150 to mix the container 5 to result in a relatively homogenous mixture corresponding to the user's desired paint. Step 313 confirms that the process is complete (e.g. mixing has stopped, components are static, etc.), and opens access to cabin 10 by controlling access element 15 and moving the access element 15 to the open position for retrieval of the container 5 from the cabin 10. Step 314 prints a receipt for the user to use for payment. Alternatively, step 314 processes payment at the machine 100.

FIG. 13 illustrates a block diagram of a computer system 500 that may be included in the system of FIG. 11 and for implementing the methods of FIG. 12 in accordance with the embodiments of the present disclosure. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for automatic selecting and mixing, in the manner prescribed by the embodiments of FIG. 12 using the selecting and mixing system 200 of FIG. 11, wherein the instructions of the computer code 597 may be executed by processor 591 via memory device 595. The computer code 597 may include software or program instructions that may implement one or more algorithms for implementing the methods for automatic selecting and mixing, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 13.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a device, a sensor, a mobile device, and the like. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 11.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to automated paint selecting and mixing systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to allow an automated paint selecting and mixing process using machine 100 accordance with embodiments of the present invention. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for automatic selecting and mixing using machine 100. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for automatic selecting and mixing.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An automated selecting and mixing machine comprising:
a cabin disposed within a housing structure, the cabin configured to receive a container from a user, the container containing a base medium;
a container engagement element, the container engagement element being movable from a first position to a second position to manipulate a lid of the container;
a plurality of dispensers, the plurality of dispensers configured to dispense an element into the container to mix with the base medium;
a mixing mechanism located in the cabin, configured to manipulate the container positioned within the cabin to achieve a mixed product; and
a user interface coupled to the housing structure, wherein a user selects the mixed product using the user interface to initiate an automated process of the automated selecting and mixing machine.

2. The automated selecting and mixing machine of claim 1, wherein the container engagement element includes a magnet configured to magnetically attach to the lid to remove the lid.

3. The automated selecting and mixing machine of claim 1, wherein the container engagement element includes a vacuum plate configured to secure the lid to remove the lid.

4. The automated selecting and mixing machine of claim 1, wherein a plurality of lid sealing elements located in the housing securably replace the lid onto the container.

5. The automated selecting and mixing machine of claim 1, wherein the mixing mechanism shakes the container to properly mix the element and the base medium.

6. The automated selecting and mixing machine of claim 1, wherein an access element to the cabin closes in response to the initiation of the automated process, and reopens upon a completion of the automated process.

7. The automated selecting and mixing machine of claim 1, further comprising a slot coupled to the housing structure, wherein a receipt generated by the user interface for payment is printed and provided to the user through the slot.

8. The automated selecting and mixing machine of claim 1, further comprising a scanner configured to scan a paint swatch to display one or more paint color suggestions relating to the paint swatch, wherein the element added to the base medium is one or more paint colorants.

9. The automated selecting and mixing machine of claim 1, further comprising a plurality of sensors in the cabin, the plurality of sensor including a wet-dry sensor, a humidity sensor, an optical sensor, and a weight sensor.

10. The automated selecting and mixing machine of claim 1, wherein:
the base medium is selected from the group consisting of: a base paint, water, alcohol, a finishing agent, a solvent, a paste, a dough, a cake mix, a dairy product, a broth, a suspension, an oil, coffee, and a combination thereof;
the element is selected from the group consisting of: a paint colorant, an ingredient, a flavoring agent, sugar, egg wash, cream, a topping, a coloring agent, a foodstuff, compressed air, a gas, a colorant, a pigment, a finishing agent, a dye, and a combination thereof; and
wherein the mixed product is selected from the group consisting of: a paint of a desired color, ice cream, a coffee, a juice, a flavored water, a wood stain, a dessert, a bakery item ready for baking, an aerated foodstuff, a foodstuff, and soup.

11. The automated selecting and mixing machine of claim 10, wherein the container engagement element includes one or more fingers, each finger of the one or more fingers include an engagement prong, configured to pry the lid off the container in the cabin.

12. The automated selecting and mixing machine of claim 1, wherein the automated selecting and mixing machine allows the user to select a desired paint color and obtain a finished paint can on a salesfloor, without a sales representative operating the automated selecting and mixing machine.

13. The automated selecting and mixing machine of claim 1, wherein the container engagement element moves in a vertical direction from the first position to the second position, further wherein when the container engagement element is in the first position, the plurality of dispensers move towards the container to dispense the element.

14. A method of automatically mixing a paint using the automated selecting and mixing machine of claim 1.

15. A method for automating a paint mixing process, comprising:
initiating the paint mixing process in response to a user selecting a paint color from a user interface;
removing a lid of a paint can placed within a cabin of a paint mixing machine by the user, wherein a paint can engagement element engages the lid of the paint can to remove the lid, further wherein the lid is temporarily attached to the paint can engagement element as the paint can engagement element retracts away from the paint can;
dispensing a paint colorant into the paint can using a plurality of paint colorant dispensers, according to a paint colorant combination corresponding to the selected paint color; and
mixing a base paint and the paint colorant.

16. The method of claim 15, wherein a mixing mechanism mixes the paint can and shakes the paint can to mix the paint colorant and the base paint.

17. The method of claim 15, wherein an access element to the cabin opens for retrieval of the paint can containing the final paint.

18. A method for automating a paint mixing process, comprising:
receiving, by a processor of a computing system, a product selection from a user operating a user interface, which initiates an automated process for obtaining a mixed product corresponding to the product selection;
detecting, by the processor, a presence of a container placed within a cabin of a mixing machine by the user, wherein an access opening to the cabin is closed in response to the detection;
instructing, by the processor, a container engagement element to remove a lid of the container, wherein the lid of the container is temporarily attached to the container engagement element as the container engagement element retracts away from the container;
determining, by the processor, a combination of elements that when combined with a base medium inside the container, results in the mixed product corresponding to the product selection;
directing, by the processor, a plurality of dispensers to dispense elements according to the combination of elements into the container; and
instructing, by the processor, a mixing mechanism to shake the container to mix the elements and the base medium;
wherein the access opening opens for retrieval of the container containing a final mixed product.

19. The method of claim 18, wherein the mixing machine is located on a salesfloor, and is operated by the user without a sales representative operating the machine.

20. The method of claim 18, wherein one or more fingers of the container engagement element include an engagement prong, configured to pry the lid off the container in the cabin.

21. The method of claim 18, wherein the container engagement element moves in a vertical direction from the first position to the second position, further wherein when the container engagement element is in the first position, the plurality of dispensers move towards the container to dispense the elements.
